(19) United States
(12) Patent Application Publication
(10) Pub. No.: US 2025/0286329 A1
(43) Pub. Date: Sep. 11, 2025

(54) Power Supply System and Electrical Connector Thereof

(71) Applicants: Dongguan Tarng Yu Electronics Co., Ltd., Dongguan City (CN); Tarng Yu Enterprise co., ltd., New Taipei City (TW)

(72) Inventors: YING-CHUNG CHEN, New Taipei City (TW); MU-JUNG HUANG, New Taipei City (TW)

(21) Appl. No.: 19/074,494

(22) Filed: Mar. 10, 2025

(30) Foreign Application Priority Data
Mar. 11, 2024 (TW) 113202437

(51) Int. Cl. H01R 13/703

(52) U.S. Cl. CPC H01R 13/703

(57) ABSTRACT

A power supply system, which comprises: an electrical connector, an inserting conductive component, and a power supply module. The power supply module is capable of providing power. The electrical connector is capable of receiving power from the power supply module, and the electrical connector comprises: a trigger component. The inserting conductive component is capable of being inserted into the electrical connector. When the inserting conductive component is fully inserted into the electrical connector, the trigger component triggers the power supply module to provide electrical power to the inserting conductive component. This can solve technical problems such as the electrical connector providing power to the inserting conductive component before it is fully inserted, ensuring that the power supplied by the electrical connector to the inserting conductive component is stable, allowing the power supply system to meet the expected power supply requirements in various electronic devices.

### CROSS-REFERENCE TO RELATED APPLICATIONS

This application claims the priority of Republic of China Patent Application No. 113202437 filed on Mar. 11, 2024, in the State Intellectual Property Office of the R.O.C., the disclosure of which is incorporated herein by reference.

### BACKGROUND OF THE INVENTION

### Field of the Invention

This application relates to the technical field of electronic devices. More specifically, it concerns an electrical connector.

### Descriptions of the Related Art

An electrical connector can be equipped with a power supply module and an inserting conductive component to form a power supply system capable of providing electrical power. In such a power supply system, the electrical connector can receive power from the power supply module and provide a connection for the inserting conductive component, thereby delivering electrical power to the inserting conductive component. As a result, in recent years, this power supply system comprises been widely used to provide electrical power to various electronic devices.

However, during practical implementation, the electrical connector may provide electrical power to the inserting conductive component before it is fully inserted, which leads to unstable power delivery to the inserting conductive component, thereby affecting the power supply of the system.

Therefore, addressing the technical issue of how to prevent the electrical connector from providing power to the inserting conductive component before it is fully inserted is an urgent challenge for those skilled in the art.

### SUMMARY OF THE INVENTION

In view of the drawbacks of the prior art mentioned above, the present application provides an electrical connector, which is able to be equipped with a power supply module and can receive an electrical power from the power supply module, and the electrical connector is able to provide insertion for an inserting conductive component, thereby providing electrical power to the inserting conductive component, and the electrical connector comprises: a trigger component, which is electrically connected to the power supply module; an inserting terminal, which is electrically connected to the power supply module and comprises an inserting terminal body, a front terminal inserting arm, and a terminal trigger arm, and the inserting terminal body is electrically connected to the terminal trigger arm, and the inserting terminal body comprises a front terminal body extension section, and the front terminal body extension section is electrically connected to the front terminal inserting arm, wherein the front terminal inserting arm comprises a front terminal inserting arm inserting structure, and the terminal trigger arm comprises a terminal trigger arm inserting structure and a terminal trigger arm abutting structure; and an insulating core, which comprises a core abutting space, a core inserting space, and a core guiding structure, and the insulating core is respectively mated with the inserting terminal and the trigger component, such that the front terminal inserting arm inserting structure and the terminal trigger arm abutting structure are respectively located within the core inserting space, and the terminal trigger arm abutting structure and the trigger component are respectively located within the core abutting space, and the core guiding structure provides guidance for the insertion of the inserting conductive component, allowing the inserting conductive component to enter the core inserting space and sequentially insert the front terminal inserting arm inserting structure and the terminal trigger arm inserting structure; wherein when the inserting conductive component inserts the front terminal inserting arm inserting structure, the inserting conductive component is electrically connected to the front terminal inserting arm inserting structure; and when the inserting conductive component inserts the terminal trigger arm inserting structure, the terminal trigger arm abutting structure is electrically abutted against the trigger component within the core abutting space, triggering the power supply module through the trigger component, thereby allowing the power supply module to provide electrical power to the inserting conductive component via the front terminal inserting arm inserting structure.

Preferably, the electrical connector said above, wherein the trigger component triggers the power supply module, and the power supply module can further provide electrical power to the inserting conductive component via the terminal trigger arm inserting structure.

Preferably, the electrical connector said above, wherein the inserting terminal further comprises a rear terminal inserting arm, and the inserting terminal body further comprises a rear terminal body extension section, and the rear terminal body extension section is electrically connected to the rear terminal inserting arm, wherein, the rear terminal inserting arm comprises a rear terminal inserting arm inserting structure and a rear terminal inserting arm supporting structure, and the rear terminal body extension section comprises a rear terminal body extension section supporting structure, and the rear terminal inserting arm is located behind the front terminal inserting arm, and the rear terminal body extension section is located behind the front terminal body extension section, such that the rear terminal inserting arm supporting structure provide support to the front terminal inserting arm, and the rear terminal body extension section supporting structure provide support to the front terminal body extension section; the rear terminal inserting arm inserting structure is located within the core inserting space, when the inserting conductive component enters the core inserting space, the inserting conductive component can insert the rear terminal inserting arm inserting structure, wherein the time when the inserting conductive component inserts the rear terminal inserting arm inserting structure is earlier than the time when the inserting conductive component inserts the terminal trigger arm inserting structure; and when the inserting conductive component inserts the terminal trigger arm inserting structure, the power supply module can further provide electrical power to the inserting conductive component via the rear terminal inserting arm inserting structure.

Preferably, the electrical connector said above, wherein the trigger component comprises a trigger component mating extension section, a trigger component abutting extension section, and a trigger component supporting extension section, and the insulating core is mated with the trigger component mating extension section, such that the trigger component abutting extension section is located in the core abutting space, when the inserting conductive component inserts the terminal trigger arm inserting structure, the terminal trigger arm abutting structure is electrically abutted against the trigger component abutting extension section in the core abutting space, and the trigger component supporting extension section abuts the insulating core, providing support to the trigger component abutting extension section.

Preferably, the electrical connector said above, wherein the insulating core further comprises a trigger component stop structure, providing support to the trigger component abutting extension section in the trigger component supporting extension section, and the trigger component stop structure provides stop to the trigger component supporting extension section to prevent the trigger component supporting extension section from leaving the insulating core.

Preferably, the electrical connector said above, wherein the trigger component supporting extension section comprises a trigger component supporting extension section elastic structure, and the trigger component supporting extension section elastic structure provides elastic support to the trigger component abutting extension section, allowing the trigger component abutting extension section to be positioned in a predetermined location within the core abutting space.

Preferably, the electrical connector said above, wherein the trigger component supporting extension section elastic structure is a bent structure.

Preferably, the electrical connector said above, wherein the trigger component abutting extension section and the trigger component supporting extension section can be combined to form a bent structure.

Preferably, the electrical connector said above, wherein the terminal trigger arm comprises a terminal trigger arm mating extension section, a terminal trigger arm abutting extension section, and a terminal trigger arm elastic extension section, wherein the insulating core is mated with the terminal trigger arm mating extension section, such that the terminal trigger arm abutting extension section is located within the core abutting space, and allowing the terminal trigger arm elastic extension section to provide a terminal trigger arm elastic extension section thrust to push the terminal trigger arm abutting extension section away from the trigger component via the terminal trigger arm elastic extension section thrust; when the inserting conductive component inserts the terminal trigger arm inserting structure, the inserting conductive component provides an inserting conductive component thrust to the terminal trigger arm abutting extension section; and when the inserting conductive component thrust is greater than the terminal trigger arm elastic extension section thrust, the terminal trigger arm abutting extension section is moved and abuts against the trigger component.

Preferably, the electrical connector said above, wherein the insulating core further comprises a terminal trigger arm stop structure, and the terminal trigger arm elastic extension section thrust forces the terminal trigger arm abutting extension section to move away from the trigger component, and the terminal trigger arm stop structure provides stop to the terminal trigger arm abutting extension section to prevent the terminal trigger arm abutting extension section from leaving the core abutting space.

Preferably, the electrical connector said above, wherein the insulating core further comprises a terminal trigger arm restriction structure, wherein the inserting conductive component thrust is greater than the terminal trigger arm elastic extension section thrust, and the terminal trigger arm restriction structure provides limitation on the movement path of the pushed terminal trigger arm abutting extension section to prevent the abutting extension section of the terminal trigger arm from abutting the trigger component in an unexpected manner.

Preferably, the electrical connector said above, wherein the trigger component and the inserting terminal are conductive metal bodies.

Additionally, the present application further provides an electric power supply system, comprising: an inserting conductive component; a power supply module capable of providing electric power; and an electrical connector, comprising: a trigger component electrically connected to the power supply module; an inserting terminal electrically connected to the power supply module, the inserting terminal comprising an inserting terminal body, a front terminal inserting arm, and a terminal trigger arm, the inserting terminal body being electrically connected to the terminal trigger arm and the front terminal inserting arm, wherein the front terminal inserting arm comprises a front terminal inserting arm joining structure, and the terminal trigger arm comprises a terminal trigger arm joining structure and a terminal trigger arm abutting structure; and an insulating core, comprising a core abutting space, a core inserting space, and a core guiding structure, the insulating core joining the inserting terminal so that the front terminal inserting arm joining structure and the terminal trigger arm abutting structure are located within the core inserting space, and the terminal trigger arm abutting structure enters the core abutting space, the core guiding structure providing guidance for the insertion of the inserting conductive component, allowing the inserting conductive component to enter the core inserting space and sequentially insert the front terminal inserting arm joining structure and the terminal trigger arm joining structure; wherein, when the inserting conductive component joins the front terminal inserting arm joining structure, the inserting conductive component is electrically connected to the front terminal inserting arm joining structure; and when the inserting conductive component joins the terminal trigger arm joining structure, the terminal trigger arm abutting structure electrically abuts the trigger component within the core abutting space, triggering the power supply module by transmitting a trigger signal via the trigger component, so that the power supply module provides electric power to the inserting conductive component via the front terminal inserting arm joining structure.

Preferably, the electric power supply system said above, wherein the trigger component triggers the power supply module, and the power supply module can further provide electric power to the inserting conductive component via the terminal trigger arm joining structure.

Preferably, the electric power supply system said above, wherein the power supply module is disposed on a circuit substrate.

Preferably, the electric power supply system said above, further comprising a trigger cable and an inserting cable, the trigger cable electrically connecting the trigger component and the power supply module, and the inserting cable electrically connecting the inserting terminal and the power supply module.

Preferably, the electric power supply system said above, wherein the trigger component comprises a trigger component cable-clamping structure, which clamps the trigger cable to electrically connect the trigger component; and the inserting terminal comprises an inserting terminal cable-clamping structure, and the inserting terminal cable-clamping structure clamps the inserting cable, enabling the inserting cable to electrically connect the inserting terminal.

Compared to the prior art, the present application provides a power supply system, which comprises: an electrical connector, an inserting conductive component, and a power supply module. The power supply module is capable of providing power. The electrical connector is capable of receiving power from the power supply module, and the electrical connector comprises: a trigger component. The inserting conductive component is capable of being inserted into the electrical connector. When the inserting conductive component is fully inserted into the electrical connector, the trigger component triggers the power supply module to provide electrical power to the inserting conductive component. This can solve technical problems such as the electrical connector providing power to the inserting conductive component before it is fully inserted, ensuring that the power supplied by the electrical connector to the inserting conductive component is stable, allowing the power supply system to meet the expected power supply requirements in various electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional diagram of the power supply system of the present application in one embodiment.

FIG. 2 is a three-dimensional diagram of the electrical connector of the present application in one embodiment.

FIG. 3 is a front view diagram of the electrical connector of the present application in one embodiment.

FIG. 4 is a cross-sectional diagram of a part of the electrical connector shown in FIG. 3, taken along line AA.

FIG. 5 is a cross-sectional diagram of a part of the electrical connector shown in FIG. 3, taken along line A′A′.

FIG. 6 is a cross-sectional diagram of a part of the electrical connector shown in FIG. 3, taken along line BB.

FIG. 7 is a cross-sectional diagram of a part of the electrical connector shown in FIG. 3, taken along line B′B′.

FIG. 8 is a cross-sectional diagram of a part of the electrical connector shown in FIG. 3, taken along line B″B″.

FIG. 9 is a three-dimensional diagram of the trigger component of the present application in one embodiment.

FIG. 10 is a right-side diagram of the electrical connector of the present application in one embodiment.

FIG. 11 is a cross-sectional diagram of a part of the electrical connector shown in FIG. 10, taken along line CC.

FIG. 12 is a cross-sectional diagram of a part of the electrical connector shown in FIG. 10, taken along line DD.

FIG. 13 is a three-dimensional diagram of a part of the electrical connector of the present application in one embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

This application provides a power supply system, which comprises: an electrical connector, an inserting conductive component, and a power supply module. The power supply module is capable of providing power. The electrical connector is capable of receiving power from the power supply module, and the electrical connector comprises: a trigger component. The inserting conductive component is capable of being inserted into the electrical connector. When the inserting conductive component is inserted into the electrical connector, the trigger component triggers the power supply module to provide electrical power to the inserting conductive component. This solves technical problems such as the electrical connector providing power to the inserting conductive component before it is fully inserted, ensuring stable power delivery from the electrical connector to the inserting conductive component and allowing the power supply system to meet the expected power supply requirements for various electronic devices.

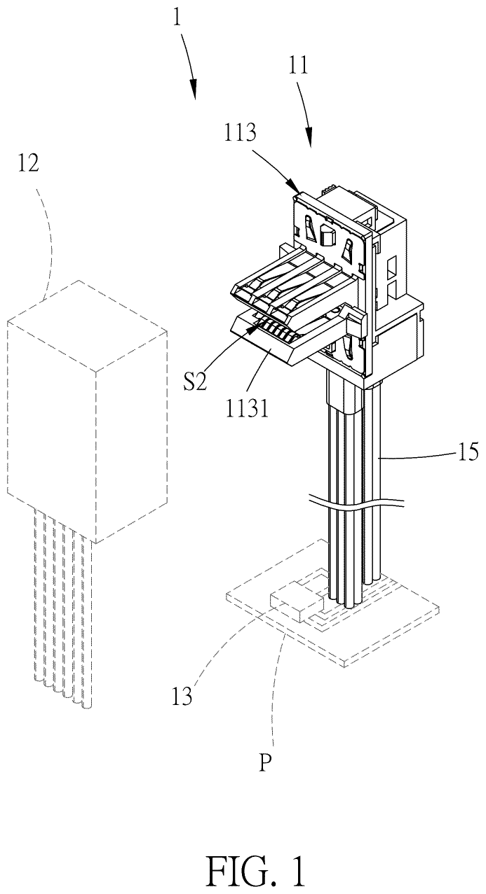

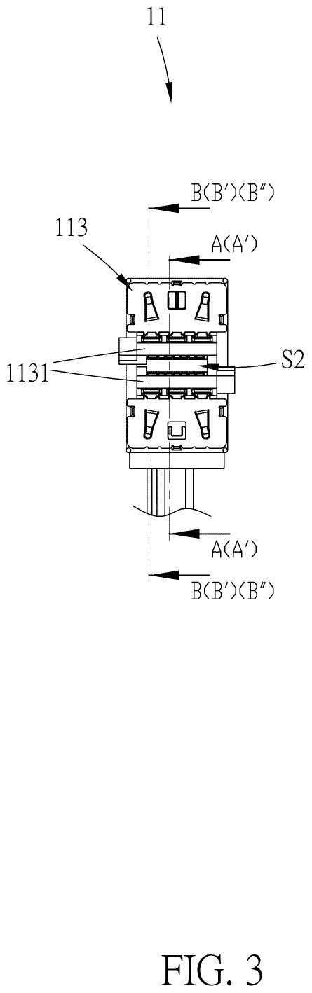

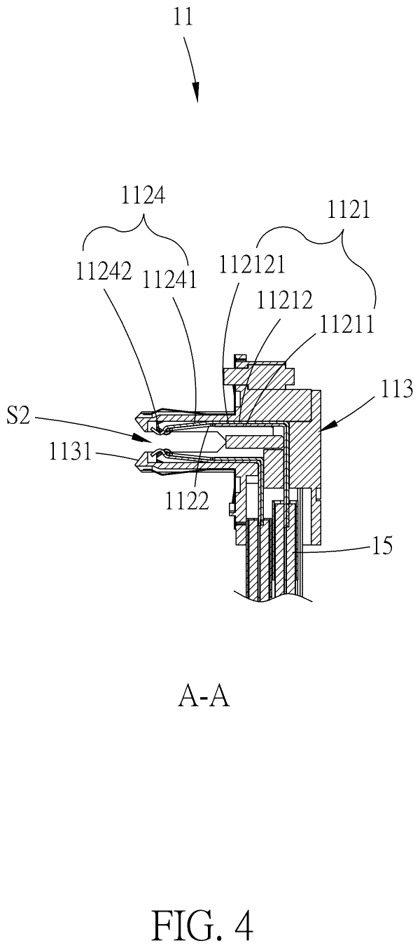

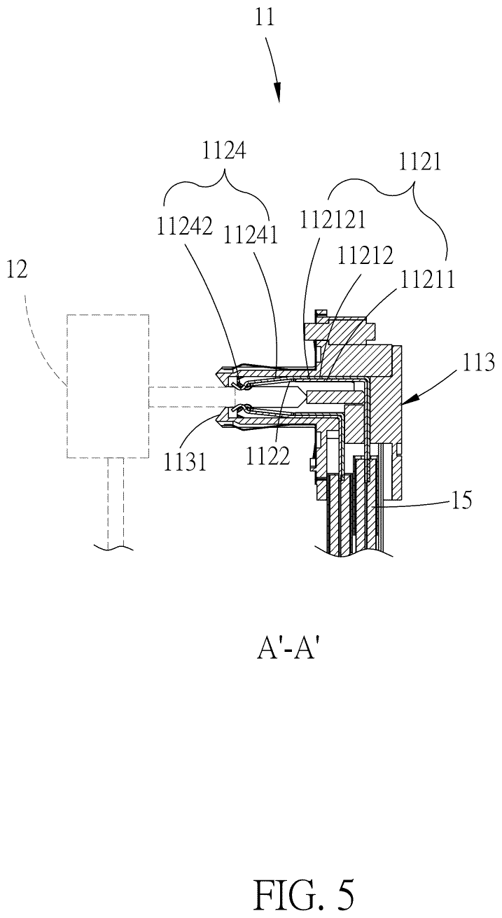

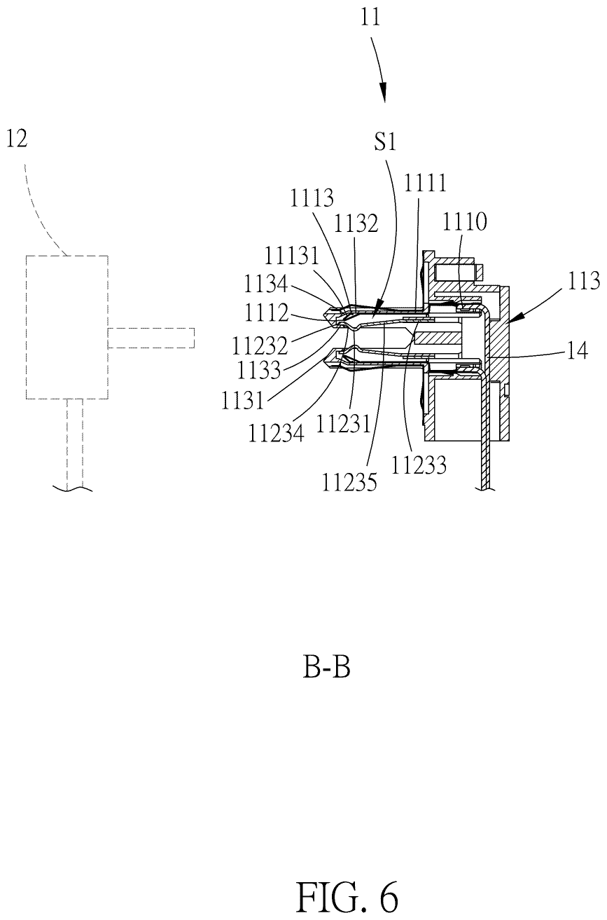

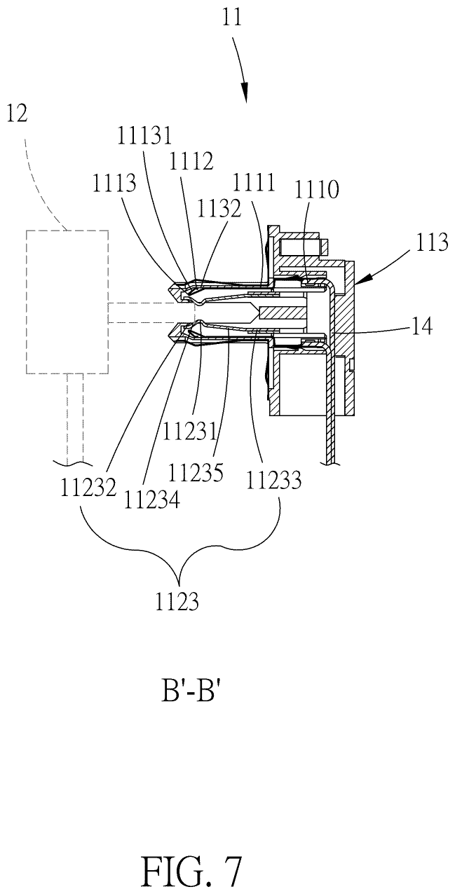

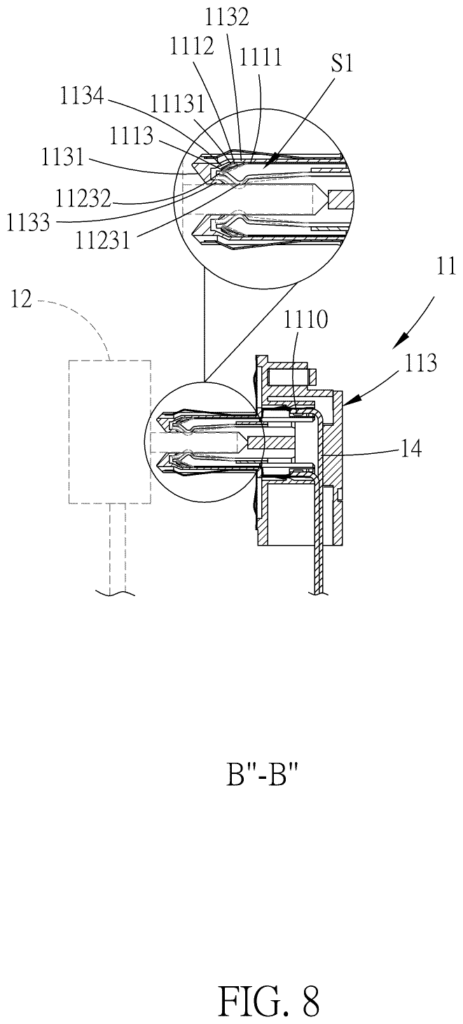

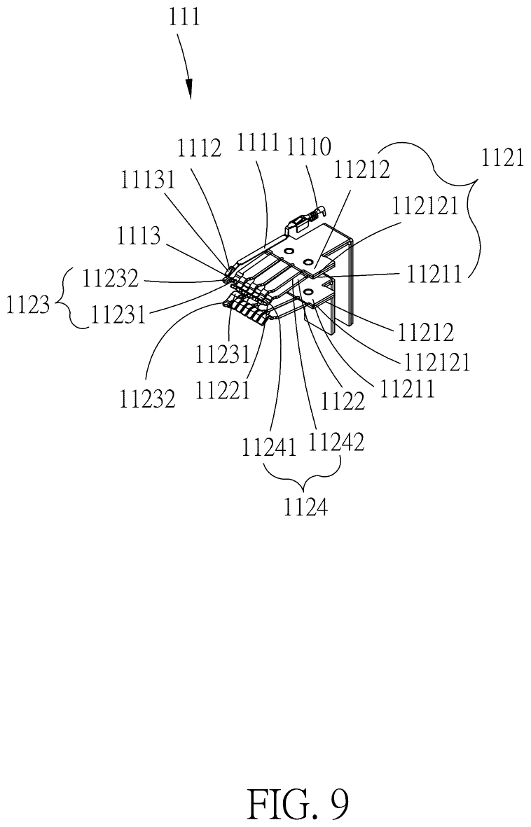

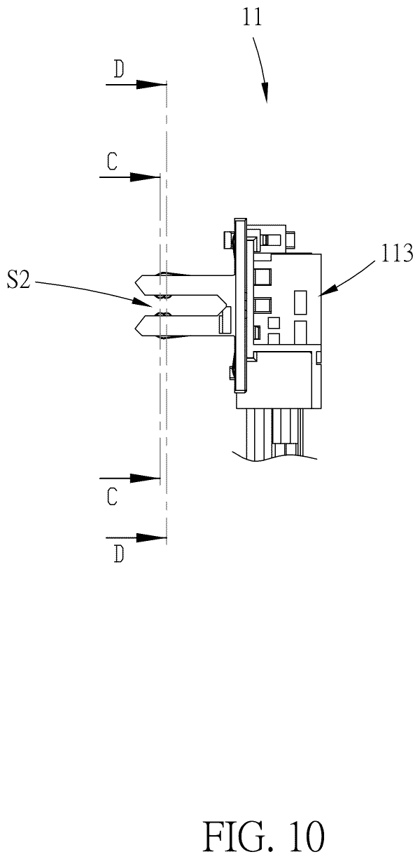

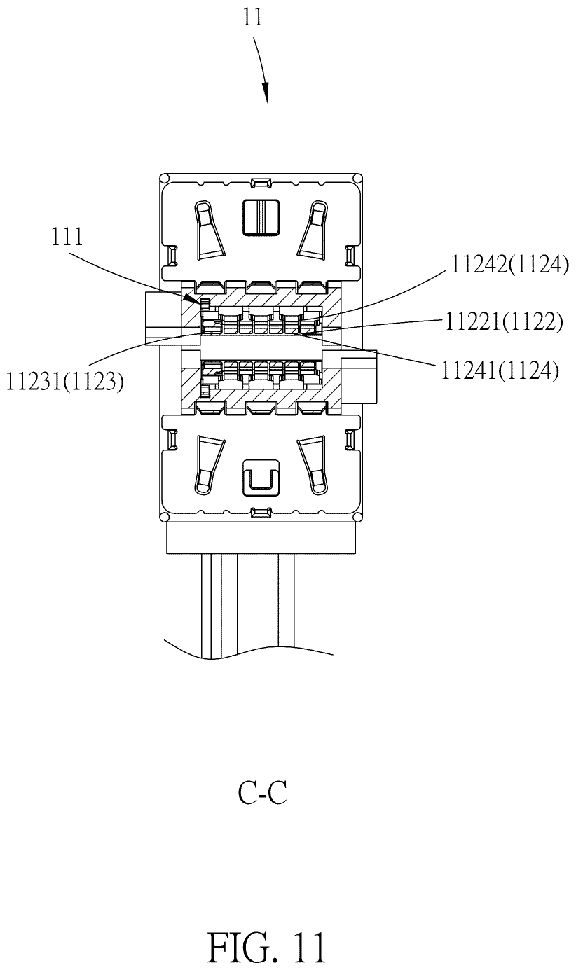

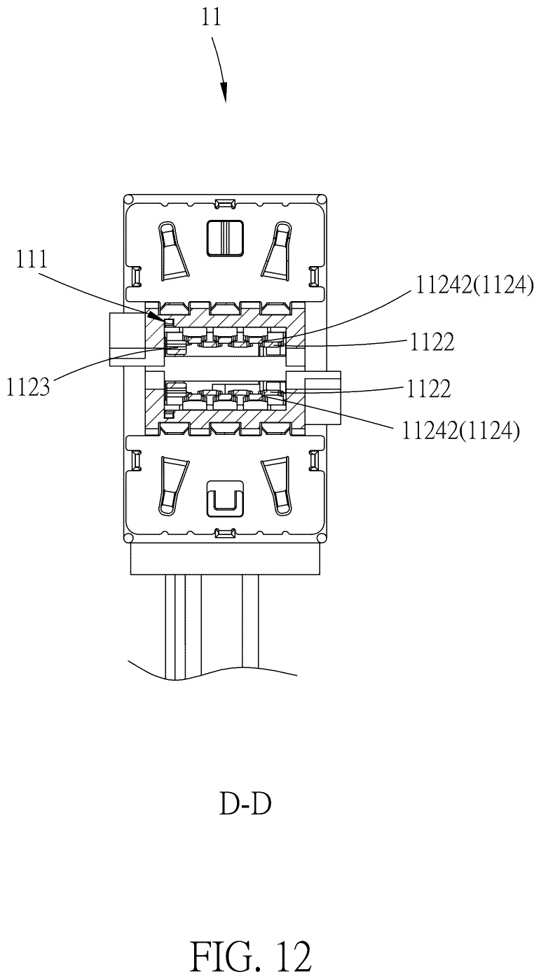

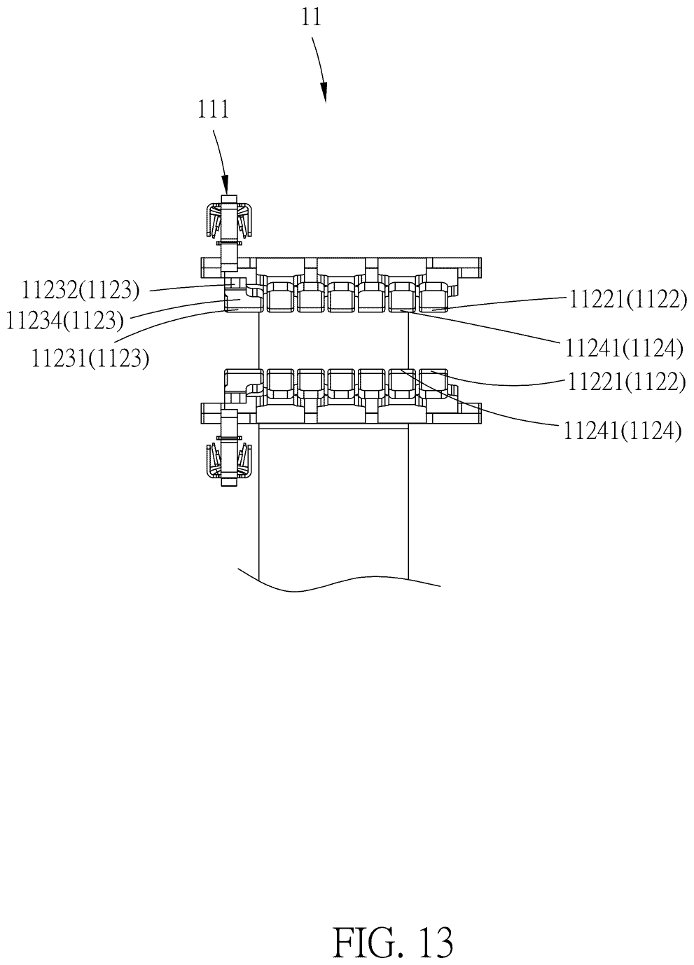

For a detailed description of the embodiments disclosed in the present application, please refer to FIGS. 1 to 13.

In the embodiments shown in FIGS. 1 to 13, at least one power supply system 1 is provided, which may comprise: an electrical connector 11, an inserting conductive component 12, a power supply module 13, a trigger cable 14, and an inserting cable 15. The power supply module 13 may optionally be arranged on a circuit substrate P to provide electrical power.

The electrical connector 11 comprises: a trigger component 111, an inserting terminal 112, and an insulating core 113. Optionally, the trigger component 111 and the inserting terminal 112 are conductive metal bodies capable of transmitting electrical signals.

The trigger component 111 comprises a trigger component cable-clamping structure 1110, a trigger component mating extension section 1111, a trigger component abutting extension section 1112, and a trigger component supporting extension section 1113. The trigger component cable-clamping structure 1110 holds one end of the trigger cable 14, while the other end of the trigger cable 14 is electrically connected to the power supply module 13, allowing the trigger component 111 to electrically connect to the power supply module 13 via the trigger cable 14.

The inserting terminal 112 comprises an inserting terminal cable-clamping structure 1120, which holds one end of the inserting cable 15, while the other end of the inserting cable 15 is electrically connected to the power supply module 13, allowing the inserting terminal 112 to electrically connect to the power supply module 13 via the inserting cable 15.

The inserting terminal 112 comprises an inserting terminal body 1121, a front terminal inserting arm 1122, a terminal trigger arm 1123, and a rear terminal inserting arm 1124. The inserting terminal body 1121 is electrically connected to the terminal trigger arm 1123 and comprises a front terminal body extension section 11211 and a rear terminal body extension section 11212. The front terminal body extension section 11211 is electrically connected to the front terminal inserting arm 1122, and the rear terminal body extension section 11212 is electrically connected to the rear terminal inserting arm 1124. The rear terminal body extension section 11212 comprises a rear terminal body extension section supporting structure 112121. The front terminal inserting arm 1122 comprises a front terminal inserting arm inserting structure 11221.

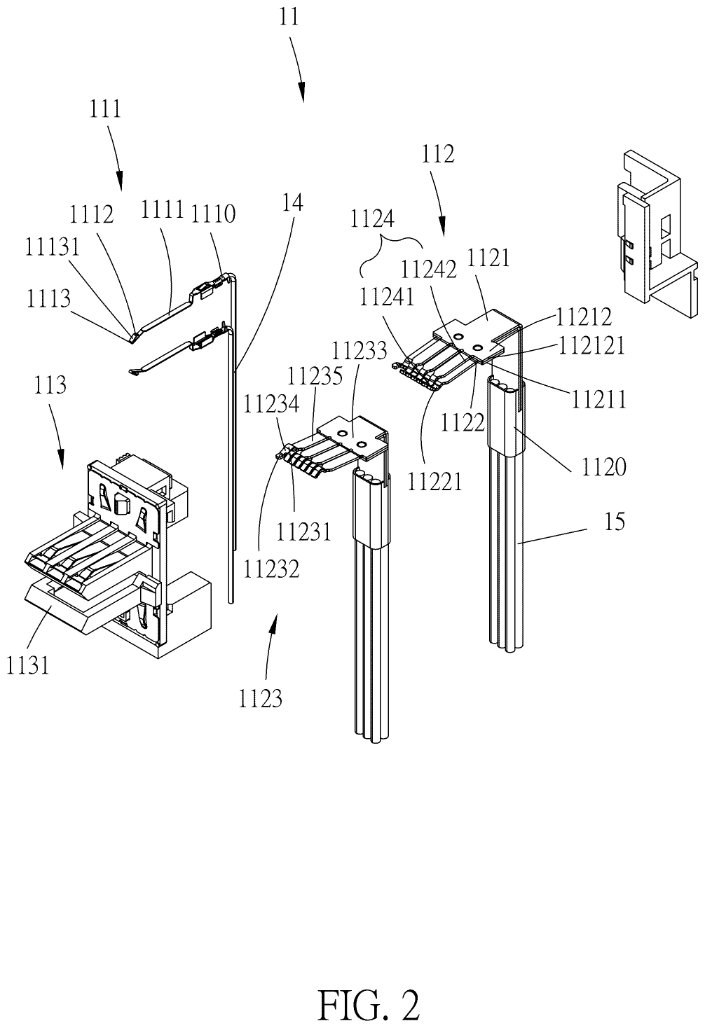

As shown in FIGS. 2 and 6 to 7, the terminal trigger arm 1123 further comprises a terminal trigger arm inserting structure 11231, a terminal trigger arm abutting structure 11232, a terminal trigger arm mating extension section 11233, a terminal trigger arm abutting extension section 11234, and a terminal trigger arm elastic extension section 11235. The terminal trigger arm abutting structure 11232 is located on the terminal trigger arm abutting extension section 11234. The rear terminal inserting arm 1124 comprises a rear terminal inserting arm inserting structure 11241 and a rear terminal inserting arm supporting structure 11242.

The insulating core 113 comprises a core abutting space S1, a core inserting space S2, a core guiding structure 1131, a trigger component stop structure 1132, a terminal trigger arm stop structure 1133, and a terminal trigger arm restriction structure 1134. The insulating core 113 is respectively mated with and positions the inserting terminal 112 (or the terminal trigger arm mating extension section 11233) and the trigger component 111 (or the trigger component mating extension section 1111), such that the front terminal inserting arm inserting structure 11221, the terminal trigger arm abutting structure 11232, and the rear terminal inserting arm inserting structure 11241 are respectively located in the core inserting space S2, and the terminal trigger arm abutting structure 11232 (or the terminal trigger arm abutting extension section 11234) and the trigger component 111 (or the trigger component abutting extension section 1112) are respectively located in the core abutting space S1. The core guiding structure 1131 provides guidance for the insertion of the inserting conductive component 12, allowing the inserting conductive component 12 to enter the core inserting space S2 and sequentially insert the front terminal inserting arm inserting structure 11221 (and/or the rear terminal inserting arm inserting structure 11241) and the terminal trigger arm inserting structure 11231. That is, the inserting conductive component 12 inserts the front terminal inserting arm inserting structure 11221 (and/or the rear terminal inserting arm inserting structure 11241) before it inserts the terminal trigger arm inserting structure 11231.

In the above embodiment, when the inserting conductive component 12 inserts the front terminal inserting arm inserting structure 11221, it electrically connects to the front terminal inserting arm inserting structure 11221. Furthermore, when the inserting conductive component 12 inserts the terminal trigger arm inserting structure 11231, the terminal trigger arm abutting structure 11232 electrically abuts the trigger component 111 (or the trigger component abutting extension section 1112) in the core abutting space S1, and the trigger component 111 transmits a trigger signal to trigger the power supply module 13. This allows the power supply module 13 to provide electrical power to the inserting conductive component 12 through the front terminal inserting arm inserting structure 11221 (and/or the rear terminal inserting arm inserting structure 11241) and the terminal trigger arm inserting structure 11231. As a result, the trigger component 111 triggers the power supply module 13 to provide electrical power to the inserting conductive component 12 only when the inserting conductive component 12 is fully inserted into the electrical connector 11. This solves technical problems such as the electrical connector 11 providing power to the inserting conductive component 12 before it is fully inserted, ensuring that the electrical connector 11 provides stable power to the inserting conductive component 12 and enabling the power supply system 1 to meet the expected power supply requirements for various electronic devices.

In the above embodiment, as shown in figure *, the rear terminal inserting arm 1124 is located behind the front terminal inserting arm 1122, and the rear terminal body extension section 11212 is located behind the front terminal body extension section 11211, such that the rear terminal inserting arm supporting structure 11242 and the rear terminal body extension section supporting structure 112121 can respectively support the front terminal inserting arm 1122 and the front terminal body extension section 11211, ensuring that the inserting conductive component 12 can be inserted into the front terminal inserting arm inserting structure 11221. The trigger component supporting extension section 1113 abuts against the insulating core 113, providing support for the trigger component abutting extension section 1112, ensuring that the trigger component abutting extension section 1112 is positioned at the predetermined location of the core abutting space S1, so that the terminal trigger arm abutting structure 11232 can electrically abut the trigger component 111 (or the trigger component abutting extension section 1112).

In the above embodiment, the terminal trigger arm elastic extension section 11235 provides a terminal trigger arm elastic extension section thrust to the terminal trigger arm abutting extension section 11234, thereby driving the terminal trigger arm abutting extension section 11234 with the terminal trigger arm elastic extension section thrust, forcing the terminal trigger arm abutting extension section 11234 to move away from the trigger component 111. Furthermore, the terminal trigger arm stop structure 1133 is, for example, a stop wall structure. When the terminal trigger arm elastic extension section thrust forces the terminal trigger arm abutting extension section 11234 to move away from the trigger component 111, the terminal trigger arm stop structure 1133 provides a stop for the terminal trigger arm abutting extension section 11234 to prevent it from leaving the core abutting space S1.

It should be noted that when the inserting conductive component 12 is inserted into the terminal trigger arm inserting structure 11231, the inserting conductive component 12 can provide an inserting conductive component thrust to the terminal trigger arm abutting extension section 11234. When the inserting conductive component thrust is greater than the terminal trigger arm elastic extension section thrust, the terminal trigger arm abutting extension section 11234 can be pushed and cause the terminal trigger arm abutting extension section 11234 (or the terminal trigger arm abutting structure 11232) to abut the trigger component 111. Additionally, the terminal trigger arm limiting structure 1134 is, for example, a stop wall structure. When the inserting conductive component thrust exceeds the terminal trigger arm elastic extension section thrust, the terminal trigger arm limiting structure 1134 limits the movement path of the pushed terminal trigger arm abutting extension section 11234, preventing the terminal trigger arm abutting extension section 11234 from abutting the trigger component 111 in an unexpected manner.

In the above embodiment, the trigger component supporting extension section 1113 comprises a trigger component supporting extension section elastic structure 11131, which can provide elastic support for the trigger component abutting extension section 1112.

Optionally, the trigger component supporting extension section elastic structure 11131 is a bent structure, so that the structural strength of the trigger component supporting extension section elastic structure 11131 meets expectations. Moreover, the trigger component abutting extension section 1112 and the trigger component supporting extension section 1113 can be combined to form a bent structure, ensuring that the structural strength of the trigger component abutting extension section 1112 and the trigger component supporting extension section 1113 meets expectations.

Additionally, the trigger component stop structure 1132 is, for example, a stop wall structure. When the trigger component supporting extension section 1113 provides support for the trigger component abutting extension section 1112, the trigger component stop structure 1132 provides a stop for the trigger component supporting extension section 1113 to prevent it from leaving the insulating core 113.

It should be noted that the power supply system and its electrical connector described in this application can omit certain components and are not limited to the above embodiment.

For example, the power supply system described in this application may optionally comprise only: the power supply system comprises: the inserting conductive component, the power supply module, and the electrical connector. The power supply module can provide electrical power. The electrical connector comprises: the trigger component, the inserting terminal, and the insulating core. The trigger component electrically connects the power supply module. The inserting terminal electrically connects the power supply module, and the inserting terminal comprises the inserting terminal body, the front terminal inserting arm, and the terminal trigger arm. The inserting terminal body electrically connects the terminal trigger arm and the inserting terminal body electrically connects the front terminal inserting arm, wherein the front terminal inserting arm comprises the front terminal inserting arm inserting structure, and the terminal trigger arm comprises the terminal trigger arm inserting structure and the terminal trigger arm abutting structure. The insulating core comprises the core abutting space, the core inserting space, and the core guiding structure. The insulating core is mated with the inserting terminal, such that the front terminal inserting arm inserting structure and the terminal trigger arm abutting structure are respectively located in the core inserting space, and the terminal trigger arm abutting structure enters the core abutting space. The core guiding structure provides guidance for inserting the conductive component, allowing the inserting conductive component to enter the core inserting space and sequentially insert the front terminal inserting arm inserting structure and the terminal trigger arm inserting structure. When the inserting conductive component is inserted into the front terminal inserting arm inserting structure, the inserting conductive component electrically connects the front terminal inserting arm inserting structure; and when the inserting conductive component is inserted into the terminal trigger arm inserting structure, the terminal trigger arm abutting structure electrically abuts the trigger component in the core abutting space, triggering the power supply module via the trigger component, causing the power supply module to provide electrical power to the inserting conductive component through the front terminal inserting arm inserting structure.

Additionally, the electrical connector described in this application may optionally comprise only: the trigger component, the inserting terminal, and the insulating core. The trigger component electrically connects the power supply module. The inserting terminal electrically connects the power supply module, and the inserting terminal comprises the inserting terminal body, the front terminal inserting arm, and the terminal trigger arm. The inserting terminal body electrically connects the terminal trigger arm, and the inserting terminal body comprises the front terminal body extension section. The front terminal body extension section electrically connects the front terminal inserting arm, wherein the front terminal inserting arm comprises the front terminal inserting arm inserting structure, and the terminal trigger arm comprises the terminal trigger arm inserting structure and the terminal trigger arm abutting structure. The insulating core comprises the core abutting space, the core inserting space, and the core guiding structure. The insulating core is respectively mated with the inserting terminal and the trigger component, such that the front terminal inserting arm inserting structure and the terminal trigger arm abutting structure are respectively located in the core inserting space, and the terminal trigger arm abutting structure and the trigger component are respectively located in the core abutting space. The core guiding structure provides guidance for inserting the conductive component, allowing the inserting conductive component to enter the core inserting space and sequentially insert the front terminal inserting arm inserting structure and the terminal trigger arm inserting structure. When the inserting conductive component is inserted into the front terminal inserting arm inserting structure, the inserting conductive component electrically connects the front terminal inserting arm inserting structure; and when the inserting conductive component is inserted into the terminal trigger arm inserting structure, the terminal trigger arm abutting structure electrically abuts the trigger component in the core abutting space, triggering the power supply module through the trigger component, causing the power supply module to provide electrical power to the inserting conductive component via the front terminal inserting arm inserting structure.

In summary, the present application provides a power supply system, which comprises: an electrical connector, an inserting conductive component, and a power supply module. The electrical connector is configured to connect the power supply module, the inserting conductive component, and the insulating core. The insulating core comprises a core abutting space, a core inserting space, and a core guiding structure. The insulating core is respectively mated withed to the inserting terminal, so that the front terminal inserting arm inserting structure and the terminal trigger arm abutting structure are respectively located in the core inserting space, and the terminal trigger arm abutting structure enters the core abutting space. The core guiding structure provides guidance for inserting the inserting conductive component, allowing the inserting conductive component to enter the core inserting space and sequentially connect with the front terminal inserting arm inserting structure and the terminal trigger arm inserting structure. When the inserting conductive component inserts the front terminal inserting arm inserting structure, the inserting conductive component is electrically connected to the front terminal inserting arm inserting structure; and when the inserting conductive component inserts the terminal trigger arm inserting structure, the terminal trigger arm abutting structure electrically abuts the trigger component in the core abutting space, triggering the power supply module via the trigger component. This causes the power supply module to provide electrical power to the inserting conductive component through the front terminal inserting arm inserting structure.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, which is able to be equipped with a power supply module and can receive an electrical power from the power supply module, and the electrical connector is able to provide insertion for an inserting conductive component, thereby providing electrical power to the inserting conductive component, and the electrical connector comprises:
a trigger component, which is electrically connected to the power supply module;
an inserting terminal, which is electrically connected to the power supply module and comprises an inserting terminal body, a front terminal inserting arm, and a terminal trigger arm, and the inserting terminal body is electrically connected to the terminal trigger arm, and the inserting terminal body comprises a front terminal body extension section, and the front terminal body extension section is electrically connected to the front terminal inserting arm, wherein the front terminal inserting arm comprises a front terminal inserting arm inserting structure, and the terminal trigger arm comprises a terminal trigger arm inserting structure and a terminal trigger arm abutting structure; and
an insulating core, which comprises a core abutting space, a core inserting space, and a core guiding structure, and the insulating core is respectively mated with the inserting terminal and the trigger component, such that the front terminal inserting arm inserting structure and the terminal trigger arm abutting structure are respectively located within the core inserting space, and the terminal trigger arm abutting structure and the trigger component are respectively located within the core abutting space, and the core guiding structure provides guidance for the insertion of the inserting conductive component, allowing the inserting conductive component to enter the core inserting space and sequentially insert the front terminal inserting arm inserting structure and the terminal trigger arm inserting structure; wherein
when the inserting conductive component inserts the front terminal inserting arm inserting structure, the inserting conductive component is electrically connected to the front terminal inserting arm inserting structure; and
when the inserting conductive component inserts the terminal trigger arm inserting structure, the terminal trigger arm abutting structure is electrically abutted against the trigger component within the core abutting space, triggering the power supply module through the trigger component, thereby allowing the power supply module to provide electrical power to the inserting conductive component via the front terminal inserting arm inserting structure.

2. The electrical connector of claim 1, wherein the trigger component triggers the power supply module, and the power supply module can further provide electrical power to the inserting conductive component via the terminal trigger arm inserting structure.

3. The electrical connector of claim 1, wherein the inserting terminal further comprises a rear terminal inserting arm, and the inserting terminal body further comprises a rear terminal body extension section, and the rear terminal body extension section is electrically connected to the rear terminal inserting arm, wherein,
the rear terminal inserting arm comprises a rear terminal inserting arm inserting structure and a rear terminal inserting arm supporting structure, and the rear terminal body extension section comprises a rear terminal body extension section supporting structure, and the rear terminal inserting arm is located behind the front terminal inserting arm, and the rear terminal body extension section is located behind the front terminal body extension section, such that the rear terminal inserting arm supporting structure provide support to the front terminal inserting arm, and the rear terminal body extension section supporting structure provide support to the front terminal body extension section;
the rear terminal inserting arm inserting structure is located within the core inserting space, when the inserting conductive component enters the core inserting space, the inserting conductive component can insert the rear terminal inserting arm inserting structure, wherein the time when the inserting conductive component inserts the rear terminal inserting arm inserting structure is earlier than the time when the inserting conductive component inserts the terminal trigger arm inserting structure; and
when the inserting conductive component inserts the terminal trigger arm inserting structure, the power supply module can further provide electrical power to the inserting conductive component via the rear terminal inserting arm inserting structure.

4. The electrical connector of claim 1, wherein the trigger component comprises a trigger component mating extension section, a trigger component abutting extension section, and a trigger component supporting extension section, and the insulating core is mated with the trigger component mating extension section, such that the trigger component abutting extension section is located in the core abutting space, when the inserting conductive component inserts the terminal trigger arm inserting structure, the terminal trigger arm abutting structure is electrically abutted against the trigger component abutting extension section in the core abutting space, and the trigger component supporting extension section abuts the insulating core, providing support to the trigger component abutting extension section.

5. The electrical connector of claim 4, wherein the insulating core further comprises a trigger component stop structure, providing support to the trigger component abutting extension section in the trigger component supporting extension section, and the trigger component stop structure provides stop to the trigger component supporting extension section to prevent the trigger component supporting extension section from leaving the insulating core.

6. The electrical connector of claim 4, wherein the trigger component supporting extension section comprises a trigger component supporting extension section elastic structure, and the trigger component supporting extension section elastic structure provides elastic support to the trigger component abutting extension section, allowing the trigger component abutting extension section to be positioned in a predetermined location within the core abutting space.

7. The electrical connector of claim 6, wherein the trigger component supporting extension section elastic structure is a bent structure.

8. The electrical connector of claim 6, wherein the trigger component abutting extension section and the trigger component supporting extension section can be combined to form a bent structure.

9. The electrical connector of claim 1, wherein the terminal trigger arm comprises a terminal trigger arm mating extension section, a terminal trigger arm abutting extension section, and a terminal trigger arm elastic extension section, wherein
the insulating core is mated with the terminal trigger arm mating extension section, such that the terminal trigger arm abutting extension section is located within the core abutting space, and allowing the terminal trigger arm elastic extension section to provide a terminal trigger arm elastic extension section thrust to push the terminal trigger arm abutting extension section away from the trigger component via the terminal trigger arm elastic extension section thrust;
when the inserting conductive component inserts the terminal trigger arm inserting structure, the inserting conductive component provides an inserting conductive component thrust to the terminal trigger arm abutting extension section; and
when the inserting conductive component thrust is greater than the terminal trigger arm elastic extension section thrust, the terminal trigger arm abutting extension section is moved and abuts against the trigger component.

10. The electrical connector of claim 9, wherein the insulating core further comprises a terminal trigger arm stop structure, and the terminal trigger arm elastic extension section thrust forces the terminal trigger arm abutting extension section to move away from the trigger component, and the terminal trigger arm stop structure provides stop to the terminal trigger arm abutting extension section to prevent the terminal trigger arm abutting extension section from leaving the core abutting space.

11. The electrical connector of claim 9, wherein the insulating core further comprises a terminal trigger arm restriction structure, wherein the inserting conductive component thrust is greater than the terminal trigger arm elastic extension section thrust, and the terminal trigger arm restriction structure provides limitation on the movement path of the pushed terminal trigger arm abutting extension section to prevent the abutting extension section of the terminal trigger arm from abutting the trigger component in an unexpected manner.

12. The electrical connector of claim 1, wherein the trigger component and the inserting terminal are conductive metal bodies.

13. An electric power supply system, comprising:
an inserting conductive component;
a power supply module capable of providing electric power; and
an electrical connector, comprising:
a trigger component electrically connected to the power supply module;
an inserting terminal electrically connected to the power supply module, the inserting terminal comprising an inserting terminal body, a front terminal inserting arm, and a terminal trigger arm, the inserting terminal body being electrically connected to the terminal trigger arm and the front terminal inserting arm, wherein the front terminal inserting arm comprises a front terminal inserting arm joining structure, and the terminal trigger arm comprises a terminal trigger arm joining structure and a terminal trigger arm abutting structure; and
an insulating core, comprising a core abutting space, a core inserting space, and a core guiding structure, the insulating core joining the inserting terminal so that the front terminal inserting arm joining structure and the terminal trigger arm abutting structure are located within the core inserting space, and the terminal trigger arm abutting structure enters the core abutting space, the core guiding structure providing guidance for the insertion of the inserting conductive component, allowing the inserting conductive component to enter the core inserting space and sequentially insert the front terminal inserting arm joining structure and the terminal trigger arm joining structure; wherein,
when the inserting conductive component joins the front terminal inserting arm joining structure, the inserting conductive component is electrically connected to the front terminal inserting arm joining structure; and
when the inserting conductive component joins the terminal trigger arm joining structure, the terminal trigger arm abutting structure electrically abuts the trigger component within the core abutting space, triggering the power supply module by transmitting a trigger signal via the trigger component, so that the power supply module provides electric power to the inserting conductive component via the front terminal inserting arm joining structure.

14. The electric power supply system of claim 13, wherein the trigger component triggers the power supply module, and the power supply module can further provide electric power to the inserting conductive component via the terminal trigger arm joining structure.

15. The electric power supply system of claim 13, wherein the power supply module is disposed on a circuit substrate.

16. The electric power supply system of claim 13, further comprising a trigger cable and an inserting cable, the trigger cable electrically connecting the trigger component and the power supply module, and the inserting cable electrically connecting the inserting terminal and the power supply module.

17. The electric power supply system of claim 16, wherein the trigger component comprises a trigger component cable-clamping structure, which clamps the trigger cable to electrically connect the trigger component; and the inserting terminal comprises an inserting terminal cable-clamping structure, and the inserting terminal cable-clamping structure clamps the inserting cable, enabling the inserting cable to electrically connect the inserting terminal.
